(19) United States
(12) Patent Application Publication
(10) Pub. No.: US 2018/0034905 A1
(43) Pub. Date: Feb. 1, 2018

(54) NETWORK APPARATUS, NETWORK SYSTEM, AND OPERATING METHOD THEREOF

(71) Applicant: WASEDA UNIVERSITY, Tokyo (JP)

(72) Inventors: Takuro Sato, Tokyo (JP); Toshitaka Tsuda, Tokyo (JP); Wataru Kameyama, Tokyo (JP); Jiro Katto, Tokyo (JP); Lopez Nacarino, Tokyo (JP)

(73) Assignee: WASEDA UNIVERSITY, Tokyo (JP)

(21) Appl. No.: 15/679,289

(22) Filed: Aug. 17, 2017

Related U.S. Application Data
(63) Continuation of application No. PCT/JP2016/000958, filed on Feb. 23, 2016.

(30) Foreign Application Priority Data
Feb. 23, 2015 (JP) 2015-033304

(51) Int. Cl. H04L 29/08; H04L 29/12

(52) U.S. Cl. CPC H04L 67/1065; H04L 61/1541; H04L 67/104; H04L 41/50

(57) ABSTRACT

A terminal network apparatus performs wireless communication with a user terminal apparatus. The terminal network apparatus receives a registration request which is transmitted from the user terminal apparatus, and assigns a node name to the user terminal apparatus. The terminal network apparatus receives a reregistration request from a user terminal apparatus which has moved from a wireless service area of another terminal network apparatus, and assigns a new node name to the user terminal apparatus. The terminal network apparatus transmits a notification that includes an old node name and the new node name to the terminal network apparatus that had assigned the old node name. When the terminal network apparatus receives the notification, the terminal network apparatus generates an entry, in which the old node name and the new node name are correlated, in a node name pair table.

### CROSS REFERENCE TO RELATED APPLICATIONS

The present application is a Continuation of PCT International Application No. PCT/JP 2016/000958 filed on Feb. 23, 2016, which claims priority under 35 U.S.C. § 119(a) to Japanese Patent Application No. 2015-033304 filed on Feb. 23, 2015. Each of the above applications is hereby expressly incorporated by reference, in its entirety, into the present application.

### BACKGROUND

The present invention is related to a network system and a network apparatus. More specifically, the present invention is related to a network system and a network apparatus which is employed to distribute content to a user terminal apparatus. In addition, the present invention is related to a method for operating the network system.

Presently, most traffic on the Internet is traffic related to the flow of content, such as web traffic and P2P traffic. Meanwhile, the basic communication model of the Internet is designed based on a location oriented communication model, which places emphasis on “where” communications are conducted with. From the viewpoint of the flow of content, users are interested in the content itself, and are not concerned from where the content is obtained. That is, users expect content provided by a content oriented communication model.

Heretofore, various measured to support content oriented communication services in an application layer have been attempted. However, the data transfer base (network) that supports such communication services remain based on a location oriented architecture, and gaps are generated between upper and lower hierarchical levels. Recently, research on content oriented networks, which focus on transmitted and received data, has been being actively conducted as a means for solving the problems caused by these gaps.

Known content oriented networks include a CCN (Content Centric Network) and an ICN (Information Centric Network) (refer to Japanese Unexamined Patent Publication No. 2009-278624, for example). In a CCN, for example, a user transmits an interest that includes the name of content to the CCN. The CCN routes the interest based on the name of the content, finds a network node which has the requested content, and forwards the content to the user from the network node.

In a CCN, a CCN router relays the interest which is transmitted by the user and the content which is forwarded to the user. At this time, the CCN router caches the content. If a request for the same content is received from another user, the CCN router obtains the content from the cache and forwards it to the other user. Users are capable of obtaining the content from a nearby CCN router, and therefore it becomes possible to reduce the amount of traffic on the network.

In connection with a CCN, T. Sato, et al., “Proactive Content Caching and Delivery Scheme utilizing Transportation Systems”, Conference of the Institute of Electronics, Information and Communications Engineers, B-6-88, March 2014 discloses content distribution that utilizes public transportation infrastructure. T. Sato, et al., “Proactive Content Caching and Delivery Scheme utilizing Transportation Systems”, Conference of the Institute of Electronics, Information and Communications Engineers, B-6-88, March 2014 discloses a system in which routers that connect user terminals and a wireless communication network are provided in train cars, and routers that communicate wirelessly with the routers in the train cars are provided at train stations. Contents are distributed to each train station ahead of time, referring to the running schedules of trains, and contents are forwarded from devices at the train stations to the routers within the train cars when the trains arrive at the train stations. Users within the train cars receive the contents from the routers within the train cars.

### SUMMARY

Here, a case in which a user connects with a node (wireless access point node) that constitutes a CCN via wireless communications, and receives content data from the wireless access point node will be considered. The user transmits an interest to the wireless access point node to which they are connected. The CCN searches for a node which holds content data having the name of content included in the interest. After the CCN finds the content data, the path of the search is traced in reverse, to transmit the content data to a user terminal. However, if the user moves and the user terminal is connected to a wireless access point node different from that to which the user terminal was connected when the interest was transmitted, it will not be possible to transmit the content data to the user from the wireless access point node to which the user terminal was connected prior to the movement. The network is not equipped with means for recognizing movement of users. The user terminal will wait for a time out, and retransmit the interest to the wireless access point node to which it became connected following movement. That is, a problem that content cannot be distributed efficiently arises.

In T. Sato, et al., “Proactive Content Caching and Delivery Scheme utilizing Transportation Systems”, Conference of the Institute of Electronics, Information and Communications Engineers, B-6-88, March 2014, users are riding trains. Therefore, even if a user moves, if content data are forwarded to routers within train cars, the content data can be delivered to the user. In addition, trains move according to schedules. Therefore, content data may be prepared in advance at each train station, and it is possible to transmit the content data to the routers within the train cars after a train arrives at each train station. However, if a user is capable of moving freely, it is not possible to specify the location of the user after an interest is transmitted, and content data cannot be prepared at a wireless access point node to which the user will become connected following movement in advance. Accordingly, the method disclosed in T. Sato, et al., “Proactive Content Caching and Delivery Scheme utilizing Transportation Systems”, Conference of the Institute of Electronics, Information and Communications Engineers, B-6-88, March 2014 cannot discriminate the destinations of users who move freely, and also cannot efficiently distribute content to users who have moved.

The present invention has been developed in view of the foregoing circumstances. It is an object of the present invention to provide a network system and a network apparatus which are capable of discriminating the destinations of users even in the case that the destinations of moving users are uncertain. In addition, it is another object of the present invention to provide a method for operating a network system.

In order to achieve the above object, the present invention provides network system comprising a plurality of terminal network apparatuses configured to wirelessly communicate with user terminal apparatuses. At least one of the plurality of terminal network apparatuses comprises: a registration request receiving unit configured to receive a first registration request transmitted from a user terminal apparatus that is present within a wireless service area of one of the terminal network apparatuses; a name assigning unit configured to assign, to the user terminal apparatus that transmitted the registration request, a node name that identifies the user terminal apparatus uniquely within the network system, and to transmit a response that includes the assigned node name to the user terminal apparatus; a reregistration request receiving unit configured to receive a reregistration request transmitted from a user terminal apparatus, which moves into the wireless service area of the one of the terminal network apparatuses from a wireless service area of another terminal network apparatus, and to which a node name has been assigned by a name assigning unit of the other terminal network apparatus; a name reassigning unit configured to assign a new node name to the user terminal apparatus that transmitted the reregistration request, and to transmit a response that includes the assigned new node name to the user terminal apparatus; a notification transmitting unit configured to generate a notification that includes the node name which had been assigned to the user terminal apparatus prior to transmission of the reregistration request and has become an old node name and the new node name assigned by the name reassigning unit, and to transmit the notification to the other terminal network apparatus which had assigned the old node name to the user terminal apparatus; and a notification receiving unit configured to receive a notification which is generated and transmitted by other terminal network apparatuses in the same manner as the notification transmitting unit, to generate an entry for a node name pair table in which an old node name and a new node name that are included in the notification are associated with each other, and to store the generated entry in a table storing unit.

In the network system of the present invention, it is preferable for the terminal network apparatus to wirelessly communicate with the user terminal apparatus employing the node name which is assigned by the name assigning unit.

It is preferable for the network system of the present invention to further comprise: at least one upper level network apparatus which is connected to at least one terminal network apparatus. The upper level network apparatus comprises a notification forwarding unit configured to forward a notification transmitted from a first terminal network apparatus to a second terminal network apparatus which has assigned the old node name, when the notification is received; and to associate the old node name and the new node name that are included in the notification with each other and to store, into a table storing unit, a node name pair table in which the old node name and the new node name are associated with each other.

In the network system of the present invention, it is preferable for the notification transmitting unit included in the first terminal network apparatus to transmit the notification to the second terminal network apparatus which has assigned the old node name via the at least one upper level network apparatus.

In the network system of the present invention, the notification which is transmitted to the second terminal network apparatus which has assigned the old node name may include data related to an expiration period of the new node name; and for the node name pair table which is stored in the table storing unit of the upper level network may be deleted from the table storing unit when the expiration period elapses.

In the network system of the present invention, it is preferable for the terminal network apparatus to further comprise: a content obtainment request receiving unit configured to receive content obtainment requests that include the node name and the name of content which is desired to be obtained; a cache unit configured to store content data; a content data obtaining unit configured to obtain, from the cache unit, content data having the name of content which is included in the content obtainment request in the case that the content data is present within the cache unit, and to generate a response that includes the obtained content data and the node name included in the content obtainment request; and a content data transmitting unit configured to transmit the response to the content obtainment request to the user terminal apparatus, based on the node name which is included in the response to the content obtainment request. In this case, it is preferable for the content data transmitting unit to refer to the table storing unit of the terminal network apparatus to judge whether an entry exists, in which the node name included in the content obtainment request matches an old node name in the node name pair table, to transmit the response to the content obtainment request to the user terminal apparatus having the node name included in the response to the content obtainment request in the case that a matching entry does not exist, and to rewrite the node name, which is included in the response to the content obtainment request, to the new node name in the entry and to transmit the response to the content obtainment request to the user terminal apparatus having the new node name in the case that a matching entry exists.

In the network system of the present invention, it is preferable for the terminal network apparatus to further comprise a content obtainment request forwarding unit configured to forward the content obtainment request received by the content request receiving unit to the upper level network apparatus. In this case, it is preferable for the content data obtaining unit to give a command to forward the content obtainment request to the content obtainment request forwarding unit in the case that content data having the name of content which is included in the content obtainment request is not present in the cache unit, and to receive a response to the content obtainment request from the upper level network apparatus to which the content obtainment request was forwarded.

In the network system of the present invention, it is preferable for the upper level network apparatus to comprise: a content obtainment request receiving unit configured to receive content obtainment requests which are forwarded from the terminal network apparatus; a cache unit configured to store the content data; a content data obtaining unit configured to obtain, from the cache unit, content data having the name of content which is included in the content obtainment request in the case that the content data is present within the cache unit, and to generate a response that includes the obtained content data and the node name included in the content obtainment request; and a content data transmitting unit configured to transmit the response to the content obtainment request to the user terminal apparatus, based on the node name which is included the response to the content obtainment request. In this case, it is preferable for the content data transmitting unit to refer to the table storing unit of the terminal network apparatus to judge whether an entry exists, in which the node name which is included in the content obtainment request matches an old node name in the node name pair table, to transmit the response to the content obtainment request to the user terminal apparatus having the node name which is included in the response to the content obtainment request in the case that a matching entry does not exist, and to rewrite the node name, which is included in the response to the content obtainment request, to the new node name in the entry and to transmit the response to the content obtainment request to the user terminal apparatus having the new node name in the case that a matching entry exists.

In the network system of the present invention, it is preferable for the upper level network apparatus to further comprise: a content obtainment request forwarding unit configured to forward the content obtainment request received by the content request receiving unit to another upper level network apparatus. In this case, it is preferable for the content data obtaining unit to give a command to forward the content obtainment request to the content obtainment request forwarding unit in the case that content data having the name of content which is included in the content obtainment request is not present in the cache unit, and to receive a response to the content obtainment request from the other upper level network apparatus to which the content obtainment request was forwarded, as a response to the forwarded content obtainment request.

In the network system of the present invention, it is preferable for the node name to include a portion which is unique to the terminal network apparatus which has assigned the node name.

In the network system of the present invention, it is preferable for the registration request to include identifying data of the user terminal apparatus; and for the reregistration request to include the identifying data of the user terminal apparatus and the assigned node name.

The present invention also provides a terminal network apparatus configured to perform wireless communication with a user terminal apparatus, comprising: a registration request receiving unit configured to receive a first registration request transmitted from a user terminal apparatus that is present within a wireless service area of one of the terminal network apparatuses; a name assigning unit configured to assign to the user terminal apparatus that transmitted the first registration request, a node name that identifies the user terminal apparatus uniquely within the network system, and to transmit a response that includes the assigned node name to the user terminal apparatus; a reregistration request receiving unit configured to receive a reregistration request transmitted from a user terminal apparatus, which moves into the wireless service area of the terminal network apparatus from a wireless service area of another terminal network apparatus, and to which a node name has been assigned by a name assigning unit of the other terminal network apparatus; a name reassigning unit configured to assign a new node name to the user terminal apparatus that transmitted the reregistration request, and to transmit a response that includes the assigned new node name to the user terminal apparatus; a notification transmitting unit configured to generate a notification that includes the node name which had been assigned to the user terminal apparatus prior to transmission of the reregistration request and has become an old node name and the new node name assigned by the name reassigning unit, and to transmit the notification to the other terminal network apparatus which had assigned the old node name to the user terminal apparatus; and a notification receiving unit configured to receive a notification which is generated and transmitted by other terminal network apparatuses in the same manner as the notification transmitting unit, to generate an entry for a node name pair table in which an old node name and a new node name that are included in the notification are associated with each other, and to store the generated entry in a table storing unit.

It is preferable for the terminal network apparatus to further comprise: a content obtainment request receiving unit configured to receive content obtainment requests that include the node name and the name of content which is desired to be obtained; a cache unit configured to store content data; a content data obtaining unit configured to obtain, from the cache unit, content data having the name of content which is included in the content obtainment request in the case that the content data is present within the cache unit, and to generate a response that includes the obtained content data and the node name included in the content obtainment request; and a content data transmitting unit configured to transmit the response to the content obtainment request to the user terminal apparatus, based on the node name which is included in the response to the content obtainment request. In this case, it is preferable for the content data transmitting unit to refer to the table storing unit to judge whether an entry exists, in which the node name included in the content obtainment request matches an old node name in the node name pair table, to transmit the response to the content obtainment request to the user terminal apparatus having the node name included in the response to the content obtainment request in the case that a matching entry does not exist, and to rewrite the node name, which is included in the response to the content obtainment request, to the new node name in the entry and to transmit the response to the content obtainment request to the user terminal apparatus having the new node name in the case that a matching entry exists.

Further, the present invention provides an upper level network apparatus configured to be connected to the terminal network apparatus of the present invention, comprising: a notification forwarding unit configured to forward a notification transmitted from a first terminal network apparatus to a second terminal network apparatus which has assigned the old node name when the notification is received, and to associate the old node name and the new node name that are included in the notification with each other, and to store, into a table storing unit, a node name pair table in which the old node name and the new node name are associated with each other.

It is preferable for the upper level network apparatus to further comprise: a content obtainment request receiving unit configured to receive content obtainment requests which are forwarded from the terminal network apparatus; a cache unit configured to store the content data; a content data obtaining unit configured to obtain, from the cache unit, content data having the name of content which is included in the content obtainment request in the case that the content data is present within the cache unit, and to generate a response that includes the obtained content data and the node name included in the content obtainment request; and a content data transmitting unit configured to transmit the response to the content obtainment request to the user terminal apparatus, based on the node name which is included the response to the content obtainment request. In this case, it is preferable for the content data transmitting unit to refer to the table storing unit to judge whether an entry exists, in which the node name which is included in the content obtainment request matches an old node name in the node name pair table, to transmit the response to the content obtainment request to the user terminal apparatus having the node name which is included in the response to the content obtainment request in the case that a matching entry does not exist, and to rewrite the node name, which is included in the response to the content obtainment request, to the new node name in the entry and to transmit the response to the content obtainment request to the user terminal apparatus having the new node name in the case that a matching entry exists.

The present invention provides a method for operating a network system comprising a plurality of terminal network apparatuses configured to wirelessly communicate with user terminal apparatuses. The method comprises the steps of: receiving a first registration request transmitted from a user terminal apparatus that is present within a wireless service area of one of the terminal network apparatus; assigning, to the user terminal apparatus that transmitted the first registration request, a node name that identifies the user terminal apparatus uniquely within the network system, and transmitting a response that includes the assigned node name to the user terminal apparatus; receiving a reregistration request transmitted from a user terminal apparatus, which moves into the wireless service area of the one of the terminal network apparatuses from a wireless service area of another one of the terminal network apparatuses, and to which a node name has been assigned by the other one of the terminal network apparatuses; assigning a new node name to the user terminal apparatus that transmitted the reregistration request, and transmitting a response that includes the assigned new node name to the user terminal apparatus; generating a notification that includes the node name which had been assigned to the user terminal apparatus prior to transmission of the registration request and has become an old node name and the new node name assigned by the name reassigning step, and transmitting the notification to the other terminal network apparatus which had assigned the old node name to the user terminal apparatus; and receiving a notification which is generated and transmitted by other terminal network apparatuses in the same manner as the notification generating and transmitting steps, and generating an entry for a node name pair table in which an old node name and a new node name that are included in the notification are associated with each other, and storing the generated entry in a table storing unit.

In the method for operating a network system of the present invention, it is preferable for the network apparatus to further comprise the steps of: receiving content data with a specification of a destination user terminal apparatus employing the node name; and referring to the table storing unit of the terminal network apparatus to judge whether an entry exists, in which the node name specified as the destination of the content data matches an old node name in the node name pair table, rewriting the node name, which is the destination of the content data, to the new node name in the entry and transmitting the content data to the user terminal apparatus having the new node name in the case that a matching entry exists.

In the present invention, the network apparatus (terminal network apparatus) assigns a node name to a user terminal apparatus which is connected thereto. The network apparatus assigns a new node name to a user terminal apparatus which has moved, when the user terminal apparatus moves. The network apparatus notifies the old node name which was assigned to the user terminal apparatus prior to movement and the newly assigned new node name to other network apparatuses. Another network apparatus (terminal network apparatus and/or upper level network apparatus) stores the old node name and the new node name in a node name pair table, thereby enabling recognition of movement of the user terminal apparatus. In the present invention, in the case that the configuration that rewrites the destination of data to the new node name in the node name pair table is adopted, the data can be transmitted to the user terminal apparatus following movement when data having the old node name as a destination is received, even in the case that the user terminal apparatus moves after requesting the data. Thereby, efficient distribution of content becomes possible.

### BRIEF DESCRIPTION OF THE DRAWINGS

FIG. 1 is a block diagram that illustrates a network system according to an embodiment of the present invention.

FIG. 2 is a block diagram that illustrates a user terminal apparatus.

FIG. 3 is a block diagram that illustrates a network apparatus which constitutes an access point node.

FIG. 4 is a block diagram that illustrates a network apparatus which constitutes a sector aggregation node.

FIG. 5 is a flow chart that illustrates the procedures from receipt of a registration request through transmission of a response thereto.

FIG. 6 is a flow chart that illustrates the procedures from receipt of a reregistration request through transmission of a response thereto.

FIG. 7 is a flow chart that illustrates the procedures from receipt of a content obtainment request through transmission of content data.

FIG. 8 is a block diagram that illustrates an example of the flow of data within the network system.

### DETAILED DESCRIPTION OF THE PREFERRED EMBODIMENTS

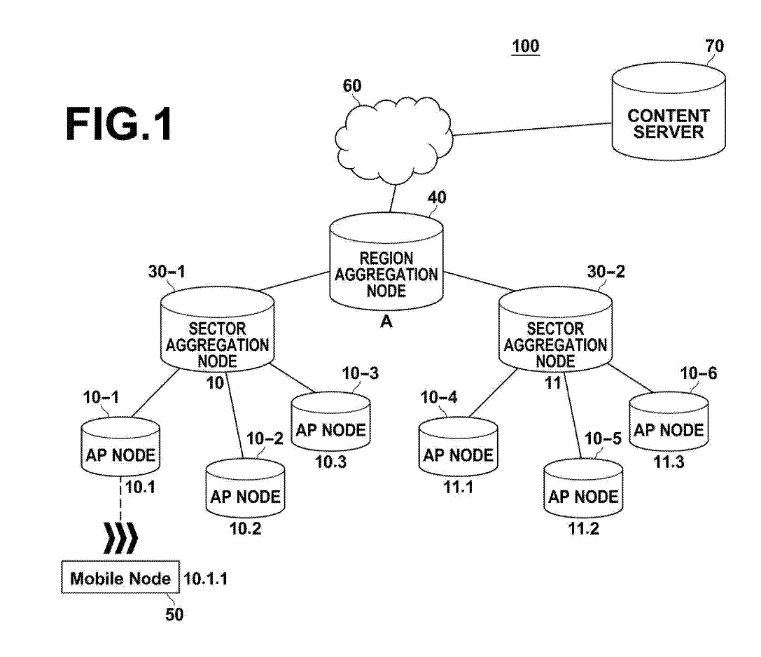

Hereinafter, an embodiment of the present invention will be described in detail with reference to the attached drawings. FIG. 1 is a block diagram that illustrates a network system according to an embodiment of the present invention. The network system (content distribution system) 100 includes a plurality of terminal network apparatuses 10-1 through 10-6, sector aggregation nodes 30-1 and 30-2, and a region aggregation network apparatus 40. These network apparatuses constitute nodes of a CCN (Content Centric Network) or an ICN (Information Centric Network). A node name that uniquely identifies each of the nodes that constitutes the network is assigned to each of the nodes.

The nodes of the network which are constituted by the network apparatuses may be broadly classified into two types of nodes, which are access point nodes and aggregation nodes. In FIG. 1, the terminal network apparatuses 10-1 through 10-6 (hereinafter, also collectively referred to as “terminal network apparatuses 10” when distinction is not particularly necessary) are the network apparatuses that constitute the access point nodes (AP nodes). The sector aggregation network apparatuses 30-1 and 30-2 and the region aggregation network apparatus 40 are the network apparatuses that constitute the aggregation nodes (upper level network apparatuses). The sector aggregation network apparatuses 30-1 and 30-2 (hereinafter, also collectively referred to as “sector aggregation network apparatuses 30” when distinction is not particularly necessary) are nodes (sector aggregation nodes) that aggregate a sector, for example, and the region aggregation network apparatus 40 is a node (region aggregation node) that aggregates a region, for example.

Note that in FIG. 1, the terminal network apparatuses 10 that constitute the AP nodes are connected to the sector aggregation network apparatuses 30 that constitute the sector aggregation nodes, and the plurality of sector aggregation network apparatuses 30 that constitute the sector aggregation nodes are connected to the region aggregation network apparatus 40 that constitutes the region aggregation node. However, this is merely an example, and the configuration of the network is not limited to this. The plurality of terminal network apparatuses 10 that constitute the AP nodes may be connected to each other, or the terminal network apparatuses 10 that constitute the AP nodes may be connected to the region aggregation network apparatus 40 that constitutes the region aggregation node. The distinction between the terminal network apparatuses and the upper level network apparatuses are for the sake of convenience. The two are not completely separate, and a portion thereof may overlap. For example, the sector aggregation network apparatuses 30 that constitute the sector aggregation nodes may function both as upper level network apparatuses and terminal network apparatuses. That is, the sector aggregation network apparatuses 30 that constitute the sector aggregation nodes may have both of the functions of aggregating the plurality of terminal network apparatuses 10 and wirelessly communicating with user terminal apparatuses 50.

The terminal network apparatuses 10 wirelessly communicate with the user terminal apparatuses 50, which are utilized by end users, by Wi-Fi, for example. The user terminal apparatuses 50 are cellular telephones such as smart phones, tablet terminal apparatuses, or apparatuses such as personal computers, for example. The region aggregation network apparatus 40 is connected to a core network 60, and is capable of obtaining content data from a content server 70, which is a server apparatus of a content provider, via the core network 60. The sector aggregation network apparatuses 30 relay communications between the terminal network apparatuses 10 and the region aggregation network apparatus 40.

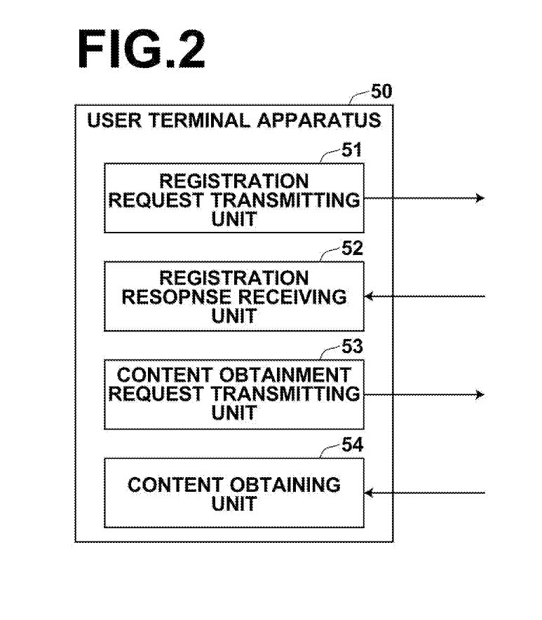

FIG. 2 is a block diagram that illustrates a user terminal apparatus 50. The user terminal apparatus 50 includes a registration request transmitting unit 51, a registration response receiving unit 52, a content obtainment request transmitting unit 53, and a content obtaining unit 54. The functions of each unit within the user terminal apparatus 50 can be realized by a processor operating according to programs that provide predetermined functions. Alternatively, at least a portion of the functions of the units within the user terminal apparatus 50 may be realized by a semiconductor device, such as an LSI.

The registration request transmitting unit 51 transmits a registration request to a terminal network apparatus 10 with which communication is possible. The registration request includes identifying data of the user terminal, for example. When the registration request is received, the terminal network apparatus 10 assigns a name (node name) to the user terminal apparatus 50 that requested registration, to be employed for further communications with the user terminal apparatus 50. The node name has a hierarchical structure that reflects a network topology, for example. The node name enables the user terminal apparatus 50 to be uniquely discriminated within the network. The node name includes a portion which is unique to the terminal network apparatus 10 which has assigned the node name. Each of the terminal network apparatuses 10 assigns a node name that indicates that user terminal apparatuses 50 are in their own domain to the user terminal apparatuses 50.

The terminal network apparatus 10 transmits a response that includes the node name, as a response to the received registration request. The registration response receiving unit 52 receives the response that includes the node name, which is transmitted by the terminal network apparatus 10. If a user terminal apparatus 50 having a node name moves to a wireless service area of a different terminal network apparatus 10, the registration request transmitting unit 51 transmits a reregistration request to the terminal network apparatus 10, into the wireless service area of which the user terminal apparatus 50 has moved. The registration response receiving unit 52 receives a new the node name from the different terminal network apparatus 10, as a response.

The content obtainment request transmitting unit 53 transmits content obtainment requests. The content obtainment requests include the name of content (content name) which is desired to be obtained, and the node name which is included in the response received by the registration response receiving unit 52. The content obtaining unit 54 receives content data from the terminal network apparatus 10 as a response to the content obtainment request. The content data is played back by a playback unit which is not illustrated, or the like.

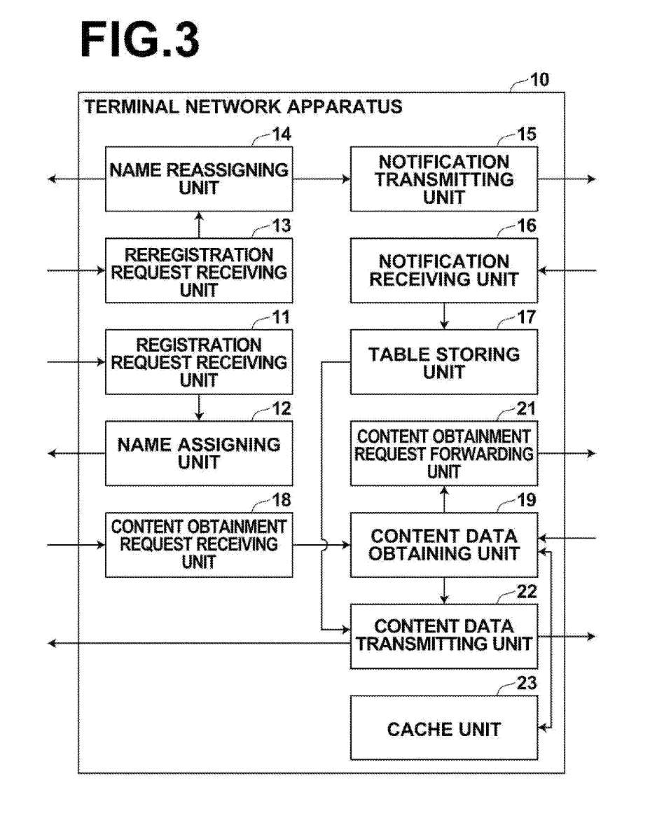

FIG. 3 is a block diagram that illustrates a terminal network apparatus 10 that constitutes an AP node. The terminal network apparatus 10 includes a registration request receiving unit 11, a name assigning unit 12, a reregistration request receiving unit 13, a name reassigning unit 14, a notification transmitting unit 15, a notification receiving unit 16, a table storing unit 17, a content obtainment request receiving unit 18, a content data obtaining unit 19, a content obtainment request forwarding unit 21, a content data transmitting unit 22, and a cache unit 23. The functions of each unit within the terminal network apparatus 10 can be realized by a processor operating according to programs that provide predetermined functions. Alternatively, at least a portion of the functions of the units within the terminal network apparatus 10 may be realized by a semiconductor device, such as an LSI.

The registration request receiving unit 11 receives the registration request transmitted from the user terminal apparatus 50 which is present in the wireless service area of the terminal network apparatus 10. The registration request includes, for example, a PoA (Point of Attachment) name as the aforementioned identifying data of the user terminal apparatus. The name assigning unit 12 assigns a name (node name) that uniquely identifies the user terminal apparatus to the user terminal apparatus 50 which has transmitted the request. The name assigning unit 12 transmits a response that includes the assigned node name to the user terminal apparatus 50. In addition, what node name has been assigned to which user terminal apparatus is stored in a storage device, which is not illustrated, as a name table. Thereafter, the terminal network apparatus 10 wirelessly communicates with the user terminal apparatus 50 employing the assigned node name.

The reregistration request receiving unit 13 receives the reregistration request from the user terminal apparatus 50 which has moved from the wireless service area of another terminal network apparatus 10 to the wireless service area of the current terminal network apparatus and whose node name has been assigned by the other terminal network apparatus 10. The reregistration request includes, for example, the node name (old node name) and the PoA name which the user terminal apparatus 50 had been utilizing. The name reassigning unit 14 assigns a new node name to the user terminal apparatus 50. The name reassigning unit 14 transmits a response that includes the newly assigned node name to the user terminal apparatus 50. Further, what node name has been assigned to which user terminal apparatus is stored in a storage device, which is not illustrated, as a name table.

When the name reassigning unit 14 assigns the new node name to the user terminal apparatus 50, the notification transmitting unit 15 transmits a notification that the node name of the user terminal apparatus 50 has been changed. This notification includes the node name (old node name) included in the reregistration request and the new node name which was newly assigned by the name reassigning unit 14. The notification transmitting unit 15 transmits a notification to the terminal network apparatus 10 which assigned the old node name. The notification transmitting unit 15 transmits the notification to the terminal network apparatus 10 which had assigned the old node name via at least one of the sector aggregation network apparatus 30 that constitutes the sector aggregation node and the region aggregation network apparatus 40 that constitutes the region aggregation node.

The notification transmitted by the notification transmitting unit 15 is received by the terminal network apparatus 10 which had assigned the old node name via several network apparatuses. The notification receiving unit 16 receives the notification transmitted by the other terminal network apparatus 10. The notification receiving unit 16 generates an entry in a node name pair table in which the old node name and the new node name which is included in the received notification are correlated with each other, and stores the generated entry in a table storage unit (storage device) 17. If the received notification is not addressed to the terminal network apparatus that includes the notification receiving unit 16, the notification receiving unit 16 forwards the notification to a destination terminal network apparatus 10.

The content obtainment request receiving unit 18 receives a content obtainment request from the user terminal apparatus 50. As described above, the content obtainment request includes a content name and a node name. The content data obtaining unit 19 obtains content data having the content name included in the content obtainment request. The content data obtaining unit 19 checks whether the content data for the requested content exists in the cache unit 23. If the content data is present in the cache unit 23, the content obtaining unit 19 obtains the content data from the cache unit 23. After the content data is obtained, the content data obtaining unit 19 generates a response that includes the content data and the node name which is included in the content obtainment request.

In the case that the content data is not present in the cache unit 23, the content data obtaining unit 19 instructs the content obtainment request forwarding unit 21 to forward the content obtainment request. The content obtainment request forwarding unit 21 forwards the content obtainment request to other terminal network apparatuses 10, the sector aggregation network apparatuses 30, or the region aggregation network apparatus 40. At this time, the content obtainment request forwarding unit 21 refers to a routing table (FIB: Forwarding Information Base) having the content name as an entry (refer to Y. Park, “New Generation Network and Information Oriented Network”, SCATLINE Vol. 94 (Winter 2014)) and forwards the request to the terminal network apparatuses 10, the sector aggregation network apparatuses 30, the region aggregation network apparatus 40, or the content server 70 which has the corresponding content data. The FIB is a naming-based routing protocol that advertises the prefixes of content names held by each terminal network apparatus, each sector aggregation network apparatus 30, and the region aggregation network apparatus 40 (refer to Y. Park, “New Generation Network and Information Oriented Network” SCATLINE Vol. 94 (Winter 2014)).

In the case that the network apparatus of the forwarding destination of the content obtainment request has the content data, the network apparatus returns a response that includes the content data and the node name which is included in the content obtainment request. In the case that the network apparatus of the forwarding destination of the content obtainment request does not have the content data, the content obtainment request is forwarded to another network apparatus. The content data is searched for in the network by forwarding the content obtainment request in this manner. After forwarding the content obtainment request, the content data obtaining unit 19 receives a response that includes the content data and the node name which is included in the content obtainment request from the network apparatus at the forwarding destination. The content data obtaining unit 19 caches the content data in the cache unit 23 according to a predetermined caching rule.

The content data transmitting unit 22 transmits a response to the content obtainment request to the user terminal apparatus 50 based on the node name which is included in the response to the content obtainment request. At this time, the content data transmitting unit 22 refers to the table storage unit 17 and judges whether an entry, in which the node name included in the response to the content obtainment request matches an old node name in the node name pair table, exists. If such an entry does not exist, the content data transmitting unit 22 transmits to the user terminal apparatus 50 which is utilizing the node name which is included in the response to the content obtainment request. If there is such an entry, the node name which is included in the response to the content obtainment request is rewritten to the new node name in the entry. The content data transmitting unit 22 transmits the response in which the node name is rewritten by the content data obtaining unit 19 to the user terminal apparatus 50 which is utilizing the rewritten node name. The response (content data) of which the node name has been rewritten reaches the terminal network apparatus 10 which has assigned the new node name via the sector aggregation network apparatus 30 which is a sector aggregation node, for example, and then transmitted to the user terminal apparatus 50 from the terminal network apparatus 10.

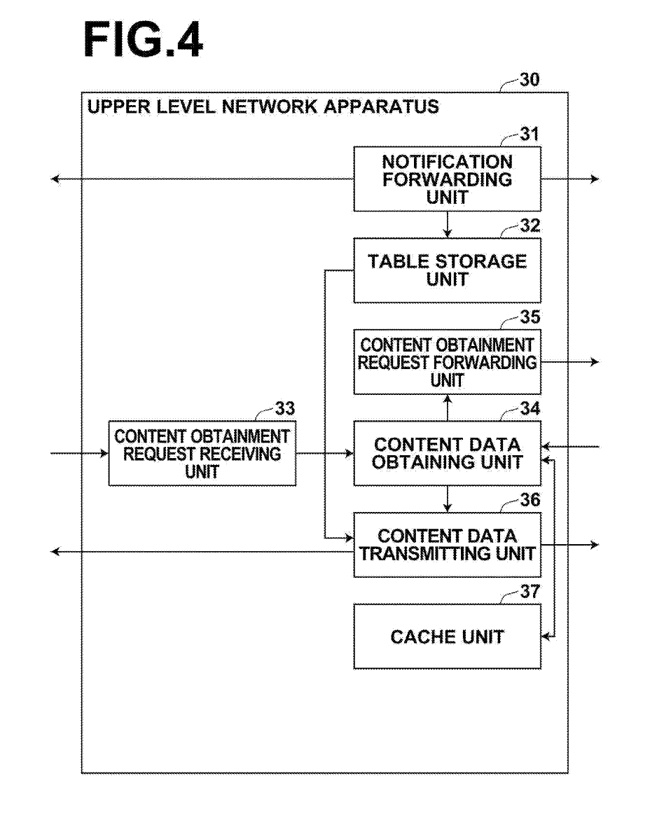

FIG. 4 is a block diagram that illustrates a sector aggregation network apparatus 30 that constitutes a sector aggregation node. The sector aggregation network apparatus 30 includes a notification forwarding unit 31, a table storage unit 32, a content obtainment request receiving unit 33, a content data obtaining unit 34, a content obtainment request forwarding unit 35, a content data transmitting unit 36, and a cache unit 37. The functions of each unit within the sector aggregation network apparatus 30 can be realized by a processor operating according to programs that provide predetermined functions. Alternatively, at least a portion of the functions of the units within the sector aggregation network apparatus 30 may be realized by a semiconductor device, such as an LSI. The region aggregation network apparatus 40 that constitutes the region aggregation node may have the same configuration as the sector aggregation network apparatus 30 that constitutes the sector aggregation node except that it is connected to the core network 60 (see FIG. 1).

The notification forwarding unit 31 receives the notification which is transmitted from the notification transmitting unit 15 (see FIG. 3) of the terminal network apparatus 10. After the notification is received, the notification forwarding unit 31 generates an entry in a node name pair table in which the old node name and the new node name which is included in the received notification are correlated with each other, and stores the generated entry in the table storage unit 32. In addition, the notification forwarding unit 31 forwards the received notification to the user terminal apparatus 50 to the terminal network apparatus 10 which has assigned the old node name.

The content obtainment request receiving unit 33, the content data obtaining unit 34, the content obtainment request forwarding unit 35, the content data transmitting unit 36, and the cache unit 37 correspond to the content obtainment request receiving unit 18, the content data obtaining unit 19, the content obtainment request forwarding unit 21, the content data transmitting unit 22, and the cache unit 23 of the terminal network apparatus 10 (see FIG. 3). The content obtainment request receiving unit 33 receives the content obtainment request transmitted from the content obtainment request forwarding unit 21 of the terminal network apparatus 10. The content data obtaining unit 34 obtains content data having the content name included in the content obtainment request. The content data obtaining unit 34 checks whether the content data for the requested content exists in the cache unit 37. In the case that the content data exists in the cache unit 37, the content data obtaining unit 34 obtains the content data from the cache unit 37. After the content data is obtained, the content data obtaining unit 34 generates a response that includes the acquired content data and the node name which is included in the content obtainment request.

In the case that the content data does not exist in the cache unit 37, the content data obtaining unit 34 instructs the content obtainment request forwarding unit 35 to forward the content obtainment request. The content obtainment request forwarding unit 35 forwards the content obtainment request to the other sector aggregation network apparatus 30 or the region aggregation network apparatus 40. The destination of the content obtainment request may be the terminal network apparatus 10. After forwarding the content obtainment request, the content data obtaining unit 34 receives a response that includes the content data and the node name from the network apparatus of the forwarding destination. After the response to the content obtainment request is received, the content data obtaining unit 34 caches the content data in the cache unit 37 according to a predetermined caching rule.

The content data transmitting unit 36 transmits a response to the content obtainment request to the user terminal apparatus 50 based on the node name which is included in the response to the content obtainment request. The content data transmitting unit 36 refers to the table storage unit 32 and determines whether an entry in which the node name included in the response to the content obtainment request acquired by the content data obtaining unit 34 or received from another network apparatus matches an old node name in the node name pair table is present. If such an entry is present, the node name which is included in the response to the content obtainment request is rewritten to the new node name of the entry, and the response to the content obtainment request is transmitted to the user terminal apparatus 50 utilizing the new node name. If such an entry is not present, the node name is not rewritten and the response to the content obtainment request is transmitted to the user terminal apparatus 50 utilizing the node name which is included in the response to the content obtainment request. The response (content data) to the transmitted content obtainment request reaches the terminal network apparatus 10 to which the node name included in the response is assigned via several sector aggregation network apparatuses 30 and/or the region aggregation network apparatus 40, and then is transmitted from the terminal network apparatus 10 to the user terminal apparatus 50.

In the description above, the content data obtaining unit 34 first generates a response to the content obtainment request, and then the content data transmitting unit 36 rewrites the node name to the new node name. However, the present invention is not limited to such a configuration. The content data obtaining unit 34 may generate a response that includes the new node name and the content data. In this case, when content is obtained, the content data obtaining unit refers to the table storage unit 32 and determines whether an entry, in which the node name included in the content obtainment request matches the old node name, is present in the node name pair table. If such an entry is present, the content data obtaining unit 34 generates a response that includes the content data and the new node name of the entry. If such an entry is not present, the content data obtaining unit 34 generates a response that includes the content data and the node name which is included in the content obtainment request as usual.

Here, in the case that the terminal network apparatus 10, the sector aggregation network apparatus 30, and the region aggregation network apparatus 40 that receive an interest, which is a type of content obtainment request from the user side (a content obtainment request is divided into segments of a certain fixed time length and sequentially transmitted), they may function as normal CCN nodes. For example, the terminal network apparatus 10 may receive an interest used in a normal CCN from a user terminal apparatus that does not have a node name, route the interest by the content name included in the interest, find a node that holds the requested content, content data may be transmitted from the node to the user terminal apparatus.

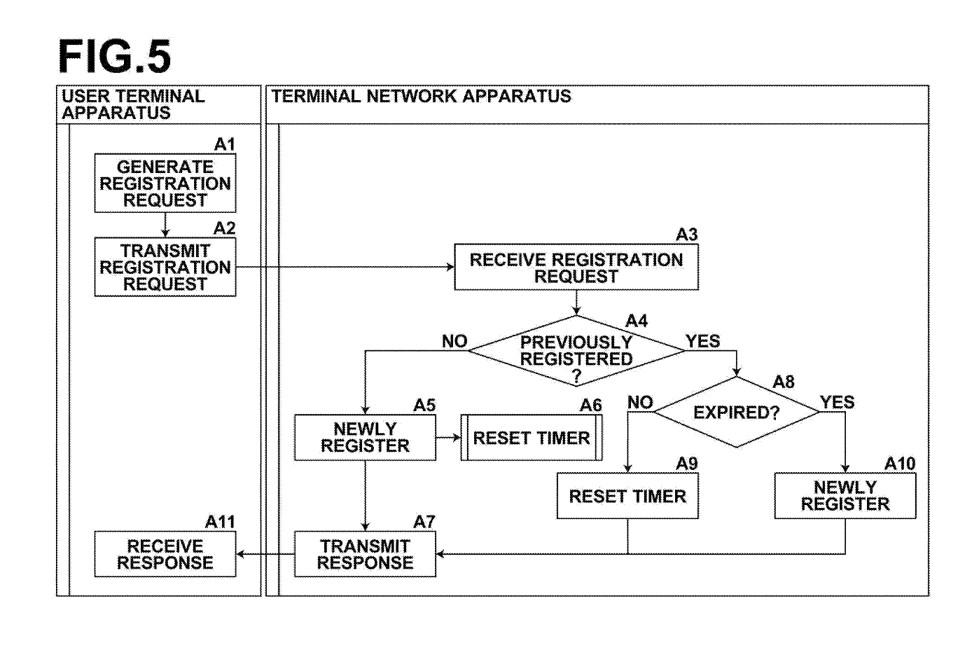

The operating steps of the present invention will be described below. FIG. 5 is a flow chart that illustrates the procedures from a registration request through transmission of a response thereto. When a user terminal apparatus 50 enters the wireless service area of a terminal network apparatus 10 that constitutes an AP node, the registration request transmitting unit 51 (see FIG. 2) of the user terminal apparatus 50 transmits a packet (EN packet: Enrollment packet) (refer to J. Lopez, et al., “Named-Node Networking (NNN) for Mobile Information Centric Networking” IEEE ICC 2015) (step A1). The EN packet includes, for example, a signature that identifies the PoA name of the user terminal apparatus. The signature includes, for example, a MAC address unique to the terminal. The user terminal apparatus 50 may include a plurality of PoA names. In this case, the user terminal apparatus 50 may include all of the PoA names in the EN packet. The plurality of PoA names are arranged according to priority, for example. In the present embodiment, the PoA name corresponds to the identifying data of the user terminal apparatus of the present invention.

The registration request transmitting unit 51 transmits the EN packet generated in step A1 to the closest terminal network apparatus 10 (step A2). The registration request receiving unit 11 (see FIG. 3) of the terminal network apparatus 10 receives the EN packet (step A3). When the terminal network apparatus 10 receives the EN packet, the name assigning unit 12 refers to the name table and checks whether the user terminal apparatus 50 that sent the EN packet has been registered previously (step A4). The name table includes, for example, a signature, a registration time, and a node name list.

In the case that it is determined that there has been no previous registration in step A4, the name assigning unit 12 newly registers the user terminal apparatus 50 (step A5). This registration is performed by adding a new entry to the name table. As the new entry is added, a signature, registration time, and assigned node name of the user terminal apparatus 50 which are included in the EN packet are recorded in the name table. The name assigning unit 12 sets a timer for the assigned node name (step A6). The timer defines a period during which the user terminal apparatus 50 can hold the node name. When the period expires, the entry is deleted from the name table.

After registration in the name table is completed, the name assigning unit 12 transmits a packet (AEN packet: Acknowledge the Enrollment packet) indicating a response to the registration request (refer to J. Lopez, et al., “Named-Node Networking (NNN) for Mobile Information Centric Networking”, IEEE ICC 2015) to the user terminal apparatus 50 (step A7). The AEN packet includes the node name which is assigned to the user terminal apparatus 50. The user terminal apparatus 50 receives the AEN packet (step A11). Thereafter, the user terminal apparatus 50 communicates using the node name which is included in the AEN packet.

In the case that it is determined that the name has been previously registered in step A4, the name assigning unit 12 determines whether the effective period of the previously registered node name has expired (step A8). The name assigning unit 12 calculates the time difference between the registration time recorded in the name table and the time at which the EN packet is received, for example. In the case that the time difference is longer than the predetermined time set as the time limit, it is determined that the effective period has expired. If it is determined that the expiration date has not expired, the registration time of the name table is rewritten to the time at which the EN packet was received, and the timer is reset (step A9). Thereafter, the process proceeds to step A7, where the AEN packet is transmitted to the user terminal apparatus 50.

In the case that it is determined that the effective period has expired at step A8, the name assigning unit 12 deletes the old entry from the name table, generates a new entry that includes a newly assigned node name, and newly registers the user terminal apparatus 50 (Step A10). Thereafter, the process proceeds to step A7, where the AEN packet is transmitted to the user terminal apparatus 50.

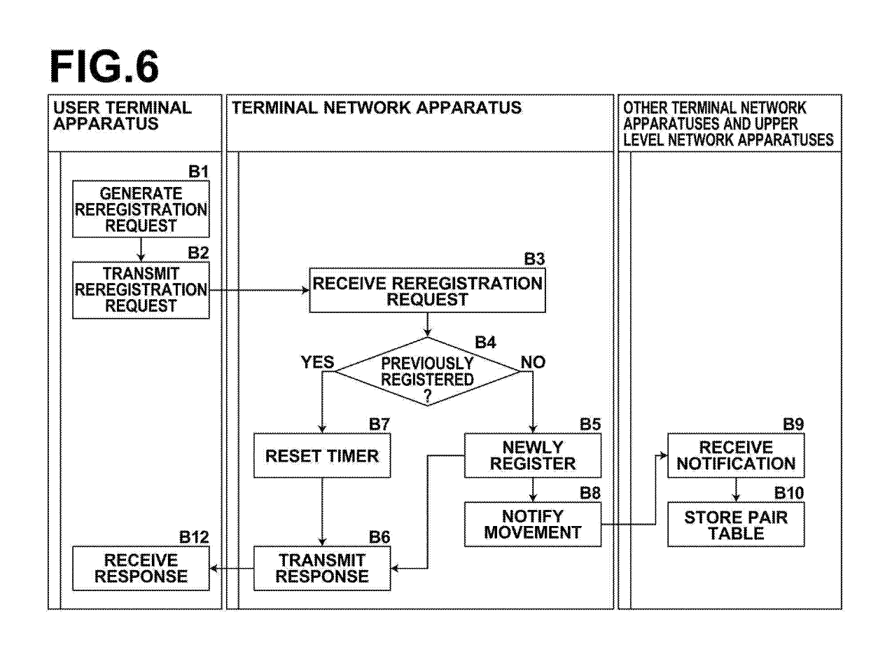

FIG. 6 is a flow chart that illustrates the procedures from receipt of a reregistration request through transmission of a response thereto. When the user terminal apparatus 50 moves between wireless service areas of the terminal network apparatuses 10, the user terminal apparatus 50 transmits a reregistration request. For example, the user terminal apparatus 50 detects a drop in the wireless power of the terminal network apparatus 10 to which it is connected, and detects that it is about to leave the wireless service area of the terminal network apparatus 10 to which it is connected. In order to continue communications after the movement, it is necessary to have a node name assigned by the terminal network apparatus 10 at the destination of the movement.

The registration request transmitting unit 51 (refer to FIG. 2) transmits a REN packet (Reenrollment packet) indicating a reregistration request (refer to J. Lopez, et al., “Named-Node Networking (NNN) for Mobile Information Centric Networking”, IEEE ICC 2015) (step B1). The REN packet includes, for example, the signature of the user terminal apparatus 50, a node name which has not expired, and a remaining time limit of the node name. The registration request transmitting unit 51 transmits the REN packet which is generated in step B1 to the destination terminal network apparatus 10 (step B2).

The reregistration request receiving unit 13 (see FIG. 3) of the destination terminal apparatus 10 receives the REN packet (step B3). After the REN packet is received, the terminal network apparatus 10 initiates a reregistration operation. The reregistration procedure is almost the same as the registration procedure. The name reassigning unit 14 refers to the name table and checks whether the user terminal apparatus 50 that sent the REN packet has previously been registered (step B4).

In the case that the name reassigning unit 14 judges that there is no previous registration in step B4, the name reassigning unit 14 generates a new node name and newly registers the user terminal apparatus 50 (step B5). This registration is performed by adding a new entry to the name table. After registration in the name table is completed, the name reassigning unit 14 transmits a packet (AEN packet) that indicates a response to the registration request to the user terminal apparatus 50 (step B6). The AEN packet includes the node name which has been newly assigned to the user terminal apparatus 50. The user terminal apparatus 50 receives the AEN packet (step B12). Thereafter, the user terminal apparatus 50 communicates utilizing the node name which is included in the AEN packet.

In the case that the name reassigning unit 14 judges that a previous registration is present in step B4, the name reassigning unit 14 resets the timer (step B7). Thereafter, the process proceeds to step B6, where an AEN packet is transmitted to the user terminal apparatus 50.

After the name reassigning unit 14 assigns a new node name, the notification transmitting unit 15 transmits a packet (INF packet: Inform packet) (refer to J. Lopez, et al, “Named-Node Networking (NNN) for Mobile Information Centric Networking” IEEE ICC 2015) to the terminal network apparatus 10 to which the node name included in the REN packet is assigned (step B8). The INF packet includes, for example, the node name (old node name) included in the REN packet, the node name (new node name) newly assigned by the name reassigning unit 14, and data regarding the effective period of the new node name.

The INF packet is received by another neighboring network apparatus, for example, a sector aggregation network apparatus 30 that constitutes a sector aggregation node or a region aggregation network apparatus 40 that constitutes a region aggregation node. Here, it is assumed that the sector aggregation network apparatus 30 receives the INF packet. The notification forwarding unit 31 of the sector aggregation network apparatus 30 (see FIG. 4) receives the INF packet (step B9). The notification forwarding unit 31 generates an entry in the node name pair table in which the old node name and the new node name included in the INF packet are correlated with each other, and stores the generated entry in the table storage unit 32 (step B10). The entry of the node name pair table which is stored in the table storage unit 32 is deleted from the table storage unit 32 after the effective period indicated by the data regarding the effective period which is included in the INF packet elapses.

The notification forwarding unit 31 transmits the INF packet to the destination terminal network apparatus 10. The INF packet is ultimately received by the notification receiving unit 16 of the terminal network apparatus 10. The notification receiving unit 16 generates an entry in the node name pair table in which the old node name and the new node name included in the received INF packet are correlated with each other, and stores the generated entry in the table storage unit 17. The network apparatuses on the route between the destination terminal apparatus 10 and the source terminal apparatus 10 relays the INF packet in this manner, and the network apparatuses that relay the INF packet and the source network apparatus 10 store the entry in the node name pair table.

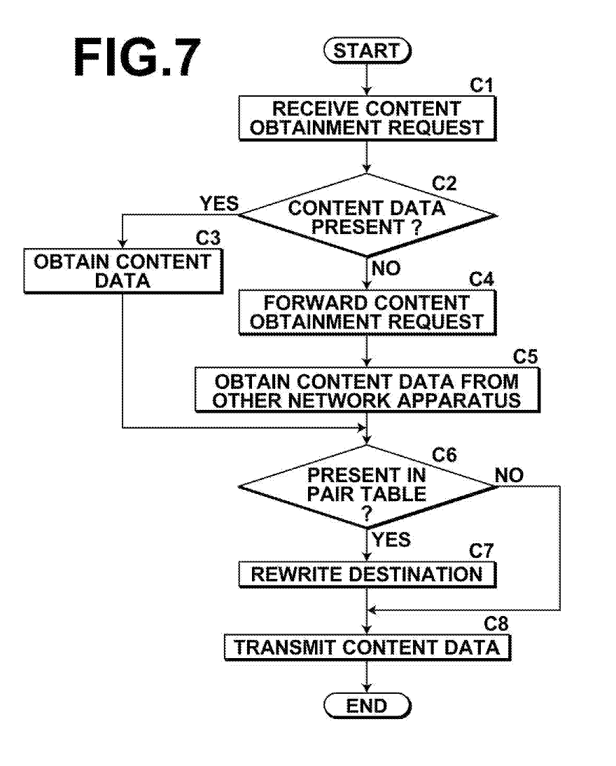

FIG. 7 is a flow chart that illustrates the procedures from receipt of a content obtainment request through transmission of content data. After receiving the AEN packet, the user terminal apparatus 50 transmits an SO packet (refer to J. Lopez, et al., “Named-Node Networking (NNN) for Mobile Information Centric Networking”, IEEE ICC 2015) that indicates the content obtainment request to the terminal network apparatus 10 that constitutes the AP node. The SO packet which is utilized for the content obtainment request includes the node name and the interest which are currently being utilized by the user terminal apparatus 50. The interest includes the name (content name) of the content data which is desired to be obtained.

The content obtainment request receiving unit 18 of the terminal network apparatus 10 receives the SO packet transmitted by the user terminal apparatus 50 (step C1). The content data obtaining unit 19 judges whether content data for the content name included in the interest exists in the cache unit 23 (step C2). In the case that the content data exists in the cache unit 23, the content data obtaining unit 19 obtains the content data from the cache unit 23 (step C3). The content data obtaining unit 19 obtains a DO packet as a response to the content obtainment request containing content data and a node name which is included in the content obtainment request (refer to J. Lopez, et al., “Named-Node Networking (NNN) for Mobile Information Centric Networking”, IEEE ICC 2015).

Next, the content data transmitting unit 22 refers to the table storage unit 17 and judges whether an entry, in which the node name included in the DO packet matches the old node name of a node name pair table, is present (step C6). If such an entry (node name pair table) is not present (“NO”), it is determined that the user terminal apparatus 50 remains in the wireless service area of the terminal network apparatus 10, and the content data transmitting unit 22 transmits the DO packet to the user terminal apparatus 50 (step C8). Accordingly, the user terminal apparatus 50 can obtain the requested content.

On the other hand, if such an entry is present (“YES”), the user terminal apparatus 50 has moved from the wireless service area of the terminal network apparatus 10 to a wireless service area of another terminal network apparatus 10, and the content data transmitting unit 22 can rewrite the node name which is included in the DO packet to the new node name which is included in the entry (step C7) and then forward it to the user terminal apparatus 50 via the destination terminal network apparatus 10.

If it is determined in step C2 that the content data does not exist in the cache unit 23, the content obtainment request forwarding unit 21 forwards the SO packet that indicates the content obtainment request to the other sector aggregation network apparatus 30 or the region aggregation network apparatus 40 (Step C4). The network apparatus of the forwarding destination is determined according to a predetermined routing strategy, for example. The content data is retrieved by repeating the transfer of the content obtainment request until the content obtainment request arrives at the network apparatus that has the content data in its cache unit 23. When the content obtainment request is forwarded to the region aggregation network apparatus 40 that constitutes the region aggregation node, the region aggregation network apparatus 40 may obtain the content data from the content server 70 via the core network 60.

The content data obtaining unit 19 receives the DO packet that includes the content data and the node name from the sector aggregation network apparatus 30 or the region aggregation network apparatus 40 as the forwarding destination of the content obtainment request (step C5). The node name which is included in the DO packet indicates the destination of the transmission destination of the DO packet. The content data obtaining unit 19 caches the content data which is included in the received DO packet in the cache unit 23 according to a predetermined caching rule.

The content data transmitting unit 22 refers to the table storage unit 17 and judges whether an entry in which the node name included in the DO packet matches the old node name is present in the node name pair table (step C6). In the case that the node name which is included in the DO packet is present as an old node name in the node name pair table (“YES” in step C6), the user terminal apparatus 50, which is the transmission source of the content obtainment request, has moved and is currently utilizing a different node name after moving. Therefore, even if the DO packet is forwarded to the terminal network apparatus 10 which has assigned the old node name, it is not possible to transmit the DO packet from the terminal network apparatus 10 to the user terminal apparatus 50.

Therefore, if it is determined in step C6 that an entry matching the old node name is present, the content data transmitting unit 22 rewrites the node name which is included in the DO packet to the new node name of the entry (step C). In other words, the content data transmitting unit 22 rewrites the destination for the content data from the old node name to the new node name. By rewriting the node name which is included in the DO packet to the new node name, even when the user terminal apparatus 50 moves after transmitting the SO packet indicating the content obtainment request, the node name which is included in the DO packet indicating the response is the node name which is being currently utilized.

The content data transmitting unit 22 transmits a DO packet indicating a response to the content obtainment request to the user terminal apparatus 50, another terminal network apparatus 10, the sector aggregation network apparatus 30, or the region aggregation network apparatus 40 (step C8). The transmission destination of the DO packet is determined according to the node name which is included therein. If the node name which is included in the DO packet is the node name assigned to the user terminal apparatus 50 by itself (in the case of “NO” in step C6), the content data transmitting unit 22 transmits the DO packet from the terminal network apparatus 10 that it is included in to the user terminal apparatus 50. In the case that the node name which is included in the DO packet is the node name assigned to the user terminal apparatus 50 by the other terminal network apparatus 10, the content data transmitting unit 22 transmits the DO packet to the terminal network apparatus 10 which has assigned the node name included in the DO packet.

The operations of the sector aggregation network apparatus 30 and the region aggregation network apparatus 40 that receive the content obtainment request which is forwarded at step C4 are basically the same as the operations of the terminal network apparatus 10 shown in FIG. 7 except that the received content obtainment request is the content obtainment request forwarded at step C4.

In the following description, a case in which the user terminal apparatus 50 transmits an EN packet to the terminal network apparatus 10-1 that constitutes an AP node in FIG. 1 will be considered. This case assumes that a node name 10.1 has been assigned to the terminal network apparatus 10-1. After the EN packet is received, the terminal network apparatus 10-1 assigns one of the node names managed by the terminal network apparatus 10-1, for example, a node name 10.1.1, to the user terminal apparatus 50, and notifies the user terminal apparatus 50 of the node name assigned thereto via an AEN packet.

After receiving the AEN packet, the user terminal apparatus 50 transmits an SO packet that includes the node name 10.1.1 and an interest to the terminal network apparatus 10-1. This SO packet is forwarded to the region aggregation network apparatus 40 that constitutes the region aggregation node via, for example, the sector aggregation network apparatus 30-1 that constitutes the sector aggregation node. The region aggregation network apparatus 40 obtains the content data having the content name included in the interest from the content server 70 via the core network 60 and transmits the DO packet including the node name 10.1.1 and the content data to the sector aggregation network apparatus 30-1. This DO packet is forwarded from the sector aggregation network apparatus 30-1 to the terminal network apparatus 10-1 and is transmitted from the terminal network apparatus 10-1 to the user terminal apparatus 50.

Consider a case in which the user terminal apparatus 50 moves from the wireless service area of the terminal network apparatus 10-1 to the wireless service area of the terminal network apparatus 10-2 in the situation described above. It is assumed that a node name 10.2 is assigned to the terminal network apparatus 10-2. The user terminal apparatus 50 transmits an REN packet that includes the node name 10.1.1 which is currently in use or had been in use immediately previously to the terminal network apparatus 10-2. Prior to transmission of the REN packet, the user terminal apparatus 50 may transmit a DEN packet (de-enrollment packet) indicating deregistration to the terminal network apparatus 10-1. The DEN packet includes the node name 10.1.1 which is currently being used. After this DEN packet is received, the terminal network apparatus 10-1 may delete the node name 10.1.1 from the name table even if the node name 10.1.1 has not expired. By deleting this node name from the name table, it becomes possible to assign the node name 10.1.1 to another user terminal apparatus after a predetermined amount of time has elapsed, for example.

After the REN packet is received, the terminal network apparatus 10-2 assigns one of the node names which are managed by the terminal network apparatus 10-2, for example, 10.2.1, to the user terminal apparatus 50. The terminal network apparatus 10-2 notifies the user terminal apparatus 50 of the new node name 10.2.1 via an AEN packet.

After the AEN packet is received, the user terminal apparatus 50 transmits the SO packet including the node name 10.2.1 and the interest to the terminal network apparatus 10-2. This SO packet is forwarded to the region aggregation network apparatus 40 that constitutes the region aggregation node via the sector aggregation network apparatus 30-1 that constitutes the sector aggregation node, for example. The region aggregation network apparatus 40 obtains content data having the content name which is included in the interest from the content server 70 via the core network 60, and transmits the DO packet that includes the node name 10.2.1 and the content data to the sector aggregation network apparatus 30-1. This DO packet is transferred from the sector aggregation network apparatus 30-1 to the terminal network apparatus 10 2, and is transmitted from the terminal network apparatus 10-2 to the user terminal apparatus 50.

Further, if the requested content is cached in the cache unit of a terminal network apparatus 10 when the user terminal apparatus 50 sends the SO packet that includes the node name 10.2.1 and the interest to the terminal network apparatus 10, the terminal network apparatus 10 generates a DO packet and transmits the content to the user terminal apparatus 50.

As described above, if the user terminal apparatus 50 does not move until the content data (DO packet) is received after transmitting the interest (SO packet) and remains in the wireless service area of the same terminal network apparatus 10, the user terminal apparatus 50 can receive the DO packet which is generated by the region aggregation network apparatus 40. However, if the user terminal apparatus 50 moves to the wireless service area of another network apparatus after transmitting the SO packet, the DO packet generated by the region aggregation network apparatus 40 cannot be received. In this case, it is necessary for the user terminal apparatus to transmit the SO packet again. However, in the present invention as described with reference to the present embodiment, the node name pairs are stored in the node name pair table in the network apparatus that constitutes the network in order to solve this problem, such that movement of the user terminal apparatus after transmission of the SO packet can be recognized.

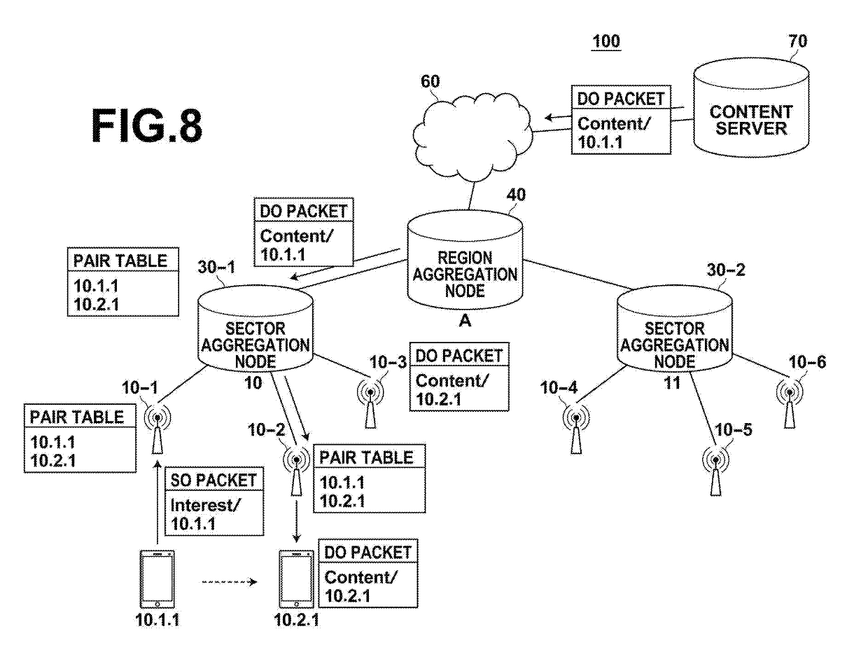

FIG. 8 is a block diagram that illustrates an example of the flow of data in the network system of the present embodiment. In the situation described above, the terminal network apparatus 10-2 transmits an INF packet for notification that includes the old node name 10.1.1 and the new node name 10.2.1 to the terminal network apparatus 10.1.1. This INF packet is transmitted to the terminal network apparatus 10-1 via the sector aggregation network apparatus 30-1 that constitutes the sector aggregation node. The sector aggregation network apparatus 30-1 which relayed the INF packet and the terminal network apparatus 10-1 which received the INF packet respectively add an entry, in which the old node name 10.1.1 and the new node name 10.1.2 are correlated with each other, to the node name pair tables thereof.

Consider a case in which the user terminal apparatus 50 transmits an REN packet to the terminal network apparatus 10-2 and a new node name 10.2.1 is assigned to the user terminal apparatus 50 after the SO packet that includes the node name 10.1.1 and the interest is transmitted to the terminal network apparatus 10-1 but before a DO packet is received. In this case, the region aggregation network apparatus 40 transmits a DO packet including the node name 10.1.1 and the content data to the sector aggregation network apparatus 30-1. The sector aggregation network apparatus 30-1 refers to the node name pair table and checks whether an entry in which the node name 10.1.1 included in the DO packet is stored as the old node name is present therein. A pair of the old node name 10.1.1 and the new node name 10.2.1 exists in the node name pair table stored by the sector aggregation network apparatus 30-1. The sector aggregation network apparatus 30-1 rewrites the node name which is included in the DO packet from 10.1.1 to 10.2.1. Because the node name which is included in the DO packet is 10.2.1, the sector aggregation network apparatus 30-1 transmits the DO packet to the terminal network apparatus 10-2. After having transmitted the SO packet that includes the node name 10.1.1, the user terminal apparatus 50 can receive the DO packet from the terminal network apparatus 10-2 using the node name 10.2.1.

In the present embodiment, the terminal network apparatus 10 that constitutes the wireless AP node assigns a node name to a user terminal apparatus 50 connected thereto. If the user terminal apparatus 50 moves, a terminal network apparatus 10 assigns a new node name to the user terminal apparatus 50 which has moved. By communicating with the terminal network apparatus 10 using the assigned node name, the user terminal apparatus 50 can form a link between the user terminal apparatus 50 and the terminal network apparatus 10.

When a new node name is assigned, the terminal network apparatus 10 transmits the old node name assigned to the user terminal apparatus 50 prior to the movement and the new node name which has been newly assigned following the movement to other terminal network apparatuses 10, the sector aggregation network apparatuses 30, and the region aggregation network apparatus 40. The other network apparatuses which have relayed or received this notification store the old node name and the new node name in a node name pair table. By referring to the node name pair table, it is possible to recognize the movement of the user terminal apparatus 50 in the network apparatus that has relayed or received the notification.

Further, in the present embodiment, when the terminal network apparatus 10, the sector aggregation network apparatus 30, or the region aggregation network apparatus 40 receives a response to a data obtainment request in which the included node name matches an old node name in the node name pair table, the network apparatus rewrites the node name which is included in the response to the new node name in the node name pair table. In other words, after the data addressed to the old node name is received, the network apparatus rewrites the destination of the data to the new node name in the node name pair table. In the case where such a configuration is adopted, even when the user terminal apparatus 50 is connected to a terminal network apparatus 10 different from the terminal network apparatus 10 to which it was connected at the time that the content obtainment request was transmitted after sending the content obtainment request, it is possible to transmit the data to the user terminal apparatus 50 after the movement. In this case, it is not necessary for the user terminal apparatus 50 to newly transmit the content obtainment request after waiting for a timeout, and efficient content distribution is possible.

In the above embodiment, a network system in which the terminal network apparatuses 10, the sector aggregation network apparatuses 30, and the region aggregation network apparatus 40 are connected in a tree shape has been described. However, the present invention is not limited to such a configuration. Alternatively, a network system in which the network apparatuses 10, the sector aggregation network apparatuses 30, and the region aggregation network apparatus 40 are mutually connected in a mesh pattern may be adopted.

Although the present invention has been described based on the preferred embodiment thereof, the network apparatus, the network system, and the operating method thereof according to the present invention are not limited only to the above embodiment. Various changes and modifications are also included in the scope of the present invention.

What is claimed is:

1. A network system comprising a plurality of terminal network apparatuses configured to wirelessly communicate with user terminal apparatuses, at least one of the plurality of terminal network apparatuses comprising:
a registration request receiving unit configured to receive a first registration request transmitted from a user terminal apparatus that is present within a wireless service area of one of the terminal network apparatuses;
a name assigning unit configured to assign, to the user terminal apparatus that transmitted the registration request, a node name that identifies the user terminal apparatus uniquely within the network system, and to transmit a response that includes the assigned node name to the user terminal apparatus;
a reregistration request receiving unit configured to receive a reregistration request transmitted from a user terminal apparatus, which moves into the wireless service area of the one of the terminal network apparatuses from a wireless service area of another terminal network apparatus, and to which a node name has been assigned by a name assigning unit of the other terminal network apparatus;
a name reassigning unit configured to assign a new node name to the user terminal apparatus that transmitted the reregistration request, and to transmit a response that includes the assigned new node name to the user terminal apparatus;
a notification transmitting unit configured to generate a notification that includes the node name which had been assigned to the user terminal apparatus prior to transmission of the reregistration request and has become an old node name and the new node name assigned by the name reassigning unit, and to transmit the notification to the other terminal network apparatus which had assigned the old node name to the user terminal apparatus; and
a notification receiving unit configured to receive a notification which is generated and transmitted by other terminal network apparatuses in the same manner as the notification transmitting unit, to generate an entry for a node name pair table in which an old node name and a new node name that are included in the notification are associated with each other, and to store the generated entry in a table storing unit.

2. A network system as defined in claim 1, wherein:
the terminal network apparatus wirelessly communicates with the user terminal apparatus employing the node name which is assigned by the name assigning unit.

3. A network system as defined in claim 1, further comprising:
at least one upper level network apparatus which is connected to at least one terminal network apparatus; wherein:
the upper level network apparatus comprises a notification forwarding unit configured to forward a notification transmitted from a first terminal network apparatus to a second terminal network apparatus which has assigned the old node name, when the notification is received; and
to associate the old node name and the new node name that are included in the notification with each other and to store into a table storing unit a node name pair table in which the old node name and the new node name are associated with each other.

4. A network system as defined in claim 3, wherein:
the notification transmitting unit included in the first terminal network apparatus transmits the notification to the second terminal network apparatus which has assigned the old node name via the at least one upper level network apparatus.

5. A network system as defined in claim 3, wherein:
the notification which is transmitted to the second terminal network apparatus which has assigned the old node name includes data related to an expiration period of the new node name; and
the node name pair table which is stored in the table storing unit of the upper level network is deleted from the table storing unit when the expiration period elapses.

6. A network system as defined in claim 3, wherein:
the terminal network apparatus further comprises:
a content obtainment request receiving unit configured to receive content obtainment requests that include the node name and the name of content which is desired to be obtained;
a cache unit configured to store content data;
a content data obtaining unit configured to obtain, from the cache unit, content data having the name of content which is included in the content obtainment request in the case that the content data is present within the cache unit, and to generate a response that includes the obtained content data and the node name included in the content obtainment request; and
a content data transmitting unit configured to transmit the response to the content obtainment request to the user terminal apparatus, based on the node name which is included in the response to the content obtainment request;
the content data transmitting unit referring to the table storing unit of the terminal network apparatus to judge whether an entry exists, in which the node name included in the content obtainment request matches an old node name in the node name pair table, transmitting the response to the content obtainment request to the user terminal apparatus having the node name included in the response to the content obtainment request in the case that a matching entry does not exist, and rewriting the node name, which is included in the response to the content obtainment request, to the new node name in the entry and transmitting the response to the content obtainment request to the user terminal apparatus having the new node name in the case that a matching entry exists.

7. A network system as defined in claim 6, wherein:
the terminal network apparatus further comprises a content obtainment request forwarding unit configured to forward the content obtainment request received by the content request receiving unit to the upper level network apparatus; and
the content data obtaining unit gives a command to forward the content obtainment request to the content obtainment request forwarding unit in the case that content data having the name of content which is included in the content obtainment request is not present in the cache unit, and receives a response to the content obtainment request from the upper level network apparatus to which the content obtainment request was forwarded.

8. A network system as defined in claim 7, wherein:
the upper level network apparatus comprises:
a content obtainment request receiving unit configured to receive content obtainment requests which are forwarded from the terminal network apparatus;
a cache unit configured to store the content data;
a content data obtaining unit configured to obtain, from the cache unit, content data having the name of content which is included in the content obtainment request in the case that the content data is present within the cache unit, and to generate a response that includes the obtained content data and the node name included in the content obtainment request; and
a content data transmitting unit configured to transmit the response to the content obtainment request to the user terminal apparatus, based on the node name which is included the response to the content obtainment request;
the content data transmitting unit referring to the table storing unit of the terminal network apparatus to judge whether an entry exists, in which the node name which is included in the content obtainment request matches an old node name in the node name pair table, transmitting the response to the content obtainment request to the user terminal apparatus having the node name which is included in the response to the content obtainment request in the case that a matching entry does not exist, and rewriting the node name, which is included in the response to the content obtainment request, to the new node name in the entry and transmitting the response to the content obtainment request to the user terminal apparatus having the new node name in the case that a matching entry exists.

9. A network system as defined in claim 8, wherein:
the upper level network apparatus further comprises:
a content obtainment request forwarding unit configured to forward the content obtainment request received by the content request receiving unit to another upper level network apparatus; and
the content data obtaining unit gives a command to forward the content obtainment request to the content obtainment request forwarding unit in the case that content data having the name of content which is included in the content obtainment request is not present in the cache unit, and receives a response to the content obtainment request from the other upper level network apparatus to which the content obtainment request was forwarded, as a response to the forwarded content obtainment request.

10. A network system as defined in claim 1, wherein:
the node name includes a portion which is unique to the terminal network apparatus which has assigned the node name.

11. A network system as defined in claim 1, wherein:
the registration request includes identifying data of the user terminal apparatus; and
the reregistration request includes the identifying data of the user terminal apparatus and the assigned node name.

12. A terminal network apparatus configured to perform wireless communication with a user terminal apparatus, comprising:
a registration request receiving unit configured to receive a first registration request transmitted from a user terminal apparatus that is present within a wireless service area of one of the terminal network apparatuses;
a name assigning unit configured to assign to the user terminal apparatus that transmitted the first registration request, a node name that identifies the user terminal apparatus uniquely within the network system, and to transmit a response that includes the assigned node name to the user terminal apparatus;
a reregistration request receiving unit configured to receive a reregistration request transmitted from a user terminal apparatus, which moves into the wireless service area of the terminal network apparatus from a wireless service area of another terminal network apparatus, and to which a node name has been assigned by a name assigning unit of the other terminal network apparatus;
a name reassigning unit configured to assign a new node name to the user terminal apparatus that transmitted the reregistration request, and to transmit a response that includes the assigned new node name to the user terminal apparatus;
a notification transmitting unit configured to generate a notification that includes the node name which had been assigned to the user terminal apparatus prior to transmission of the reregistration request and has become an old node name and the new node name assigned by the name reassigning unit, and to transmit the notification to the other terminal network apparatus which had assigned the old node name to the user terminal apparatus; and
a notification receiving unit configured to receive a notification which is generated and transmitted by other terminal network apparatuses in the same manner as the notification transmitting unit, to generate an entry for a node name pair table in which an old node name and a new node name that are included in the notification are associated with each other, and to store the generated entry in a table storing unit.

13. A terminal network apparatus as defined in claim 12, further comprising:
a content obtainment request receiving unit configured to receive content obtainment requests that include the node name and the name of content which is desired to be obtained;
a cache unit configured to store content data;
a content data obtaining unit configured to obtain, from the cache unit, content data having the name of content which is included in the content obtainment request in the case that the content data is present within the cache unit, and to generate a response that includes the obtained content data and the node name included in the content obtainment request; and
a content data transmitting unit configured to transmit the response to the content obtainment request to the user terminal apparatus, based on the node name which is included in the response to the content obtainment request;
the content data transmitting unit referring to the table storing unit to judge whether an entry exists, in which the node name included in the content obtainment request matches an old node name in the node name pair table, transmitting the response to the content obtainment request to the user terminal apparatus having the node name included in the response to the content obtainment request in the case that a matching entry does not exist, and rewriting the node name, which is included in the response to the content obtainment request, to the new node name in the entry and transmitting the response to the content obtainment request to the user terminal apparatus having the new node name in the case that a matching entry exists.

14. An upper level network apparatus configured to be connected to at least one terminal network apparatus that wirelessly communicates with a user terminal apparatus, the terminal network apparatus comprising:
a registration request receiving unit configured to receive a first registration request transmitted from a user terminal apparatus that is present within a wireless service area of one of the terminal network apparatuses;
a name assigning unit configured to assign, to the user terminal apparatus that transmitted the first registration request, a node name that identifies the user terminal apparatus uniquely within a network, and to transmit a response that includes the assigned node name to the user terminal apparatus;
a reregistration request receiving unit configured to receive a reregistration request transmitted from a user terminal apparatus, which moves into the wireless service area of the one of the terminal network apparatuses from a wireless service area of another terminal network apparatus, and to which a node name has been assigned by a name assigning unit of the other terminal network apparatus;
a name reassigning unit configured to assign a new node name to the user terminal apparatus that transmitted the reregistration request, and to transmit a response that includes the assigned new node name to the user terminal apparatus;
a notification transmitting unit configured to generate a notification that includes the node name which had been assigned to the user terminal apparatus prior to transmission of the reregistration request and has become an old node name and the new node name assigned by the name reassigning unit, and to transmit the notification to the other terminal network apparatus which had assigned the old node name to the user terminal apparatus;
a notification receiving unit configured to receive a notification which is generated and transmitted by other terminal network apparatuses in the same manner as the notification, to generate an entry for a node name pair table in which an old node name and a new node name that are included in the notification are associated with each other, and to store the generated entry in a table storing unit;
a content obtainment request receiving unit configured to receive content obtainment requests that include the node name and the name of content which is desired to be obtained;
a cache unit configured to store content data;
a content data obtaining unit configured to obtain, from the cache unit, content data having the name of content which is included in the content obtainment request in the case that the content data is present within the cache unit, and to generate a response that includes the obtained content data and the node name included in the content obtainment request; and
a content data transmitting unit configured to transmit the response to the content obtainment request to the user terminal apparatus, based on the node name which is included in the response to the content obtainment request;
the content data transmitting unit referring to the table storing unit to judge whether an entry exists, in which the node name included in the content obtainment request matches an old node name in the node name pair table, transmitting the response to the content obtainment request to the user terminal apparatus having the node name included in the response to the content obtainment request in the case that a matching entry does not exist, and rewriting the node name, which is included in the response to the content obtainment request, to the new node name in the entry and transmitting the response to the content obtainment request to the user terminal apparatus having the new node name in the case that a matching entry exists; and
the upper level network apparatus comprising;
a notification forwarding unit configured to forward a notification transmitted from a first terminal network apparatus to a second terminal network apparatus which has assigned the old node name, when the notification is received, and to associate the old node name and the new node name with each other, that are included in the notification and to store into a table storing unit a node name pair table in which the old node name and the new node name are associated with each other.

15. An upper level network apparatus as defined in claim 14, further comprising:
a content obtainment request receiving unit configured to receive content obtainment requests which are forwarded from the terminal network apparatus;
a cache unit configured to store the content data;
a content data obtaining unit configured to obtain, from the cache unit, content data having the name of content which is included in the content obtainment request in the case that the content data is present within the cache unit, and to generate a response that includes the obtained content data and the node name included in the content obtainment request; and
a content data transmitting unit configured to transmit the response to the content obtainment request to the user terminal apparatus, based on the node name which is included the response to the content obtainment request;
the content data transmitting unit referring to the table storing unit to judge whether an entry exists, in which the node name which is included in the content obtainment request matches an old node name in the node name pair table, transmitting the response to the content obtainment request to the user terminal apparatus having the node name which is included in the response to the content obtainment request in the case that a matching entry does not exist, and rewriting the node name, which is included in the response to the content obtainment request, to the new node name in the entry and transmitting the response to the content obtainment request to the user terminal apparatus having the new node name in the case that a matching entry exists.

16. A method for operating a network system comprising a plurality of terminal network apparatuses configured to wirelessly communicate with user terminal apparatuses, comprising the steps of:
receiving a first registration request transmitted from a user terminal apparatus that is present within a wireless service area of one of the terminal network apparatus;
assigning, to the user terminal apparatus that transmitted the first registration request, a node name that identifies the user terminal apparatus uniquely within the network system, and transmitting a response that includes the assigned node name to the user terminal apparatus;
receiving a reregistration request transmitted from a user terminal apparatus, which moves into the wireless service area of the one of the terminal network apparatuses from a wireless service area of another one of the terminal network apparatuses, and to which a node name has been assigned by the other one of the terminal network apparatuses;
assigning a new node name to the user terminal apparatus that transmitted the reregistration request, and transmitting a response that includes the assigned new node name to the user terminal apparatus;
generating a notification that includes the node name which had been assigned to the user terminal apparatus prior to transmission of the registration request and has become an old node name and the new node name assigned by the name reassigning step, and transmitting the notification to the other terminal network apparatus which had assigned the old node name to the user terminal apparatus; and
receiving a notification which is generated and transmitted by other terminal network apparatuses in the same manner as the notification generating and transmitting steps, and generating an entry for a node name pair table in which an old node name and a new node name that are included in the notification are associated with each other, and storing the generated entry in a table storing unit.

17. A method for operating a network system as defined in claim 16, further comprising the steps of:
receiving content data with a specification of a destination user terminal apparatus employing the node name;
and referring to the table storing unit of the terminal network apparatus to judge whether an entry exists, in which the node name specified as the destination of the content data matches an old node name in the node name pair table, rewriting the node name, which is the destination of the content data, to the new node name in the entry and transmitting the content data to the user terminal apparatus having the new node name in the case that a matching entry exists.
